(19) United States
(12) Patent Application Publication
(10) Pub. No.: US 2008/0031671 A1
(43) Pub. Date: Feb. 7, 2008

(54) RECORDING APPARATUS

(75) Inventor: Yasuhiko Ikeda, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/829,655

(22) Filed: Jul. 27, 2007

(30) Foreign Application Priority Data
Aug. 1, 2006 (JP) 2006-210032

(51) Int. Cl. B41J 1/08

(52) U.S. Cl. 400/59

(57) ABSTRACT

A recording apparatus includes a conveying roller configured to convey a sheet, a recording head configured to make a recording on the sheet, a carriage configured to reciprocate and capable of having a recording head installed therein, a guiding mechanism configured to guide the carriage, and a parallelism adjusting mechanism configured to adjust relative parallelism between the conveying roller and the guiding mechanism.

### BACKGROUND OF THE INVENTION

1. Field of the Invention

The present invention relates to recording apparatuses for making a recording on sheets conveyed by conveying rollers using recording heads that are installed in carriages to be reciprocated.

2. Description of the Related Art

A demand for higher image quality has been increasing in recording apparatuses that record images on recording media on the basis of image information. In particular, in order to improve image quality in recording apparatuses of, for example, the ink-jet type in which recording media and recording heads are not in contact with each other, distances between the recording heads and the recording media have been required to be minimized. On the other hand, when the distances become too small, the recording heads and the recording media can be brought into contact with each other. This can cause smudges on the recording media or damage to the recording heads.

Under such circumstances, some known structures have been used to adjust the distance between a recording head and a platen by transferring a guide shaft of a carriage, which travels while having the recording head installed therein, parallel to the platen in a process of assembling a recording apparatus. Moreover, other known structures have a guide shaft that guides and supports a carriage, and both end portions of the guide shaft are supported via an eccentric cam so as to be rotatable. The structures have been used to adjust the distance between a recording head and a platen by vertically transferring the guide shaft by the rotation of the eccentric cam.

However, as recording heads become long in a direction in which recording media are conveyed (conveying direction), a demand for higher accuracy in assembling recording apparatuses has become markedly stringent. In particular, it is necessary to strictly control the accuracy in the relative positions of a conveying mechanism that conveys recording media and a carriage transferring mechanism that conducts main scanning of a recording head such that streaks and unevenness in recorded images are prevented. FIGS. 10A and 10B illustrate the relationship between the length of a recording head (nozzle lines thereof) in the conveying direction in an ink-jet recording apparatus and displacement on recorded images when the recording head scans a plurality of times. The length of the nozzle lines in the conveying direction is relatively small in FIG. 10A, whereas the length of the nozzle lines in the conveying direction is relatively large in FIG. 10B. When the length of the nozzle lines is small (L1), the displacement in images is defined as d1. When the length of the nozzle lines is large (L2), the displacement in images is defined as d2. When L2 is twice as long as L1 (L2=L1×2), d2 becomes twice as long as d1 (d2=d1×2). That is, when the length of the nozzle lines becomes large, streaks or levels of unevenness occurring in images are markedly increased, resulting in reduction in image quality.

### SUMMARY OF THE INVENTION

The present invention is directed to a recording apparatus capable of relatively adjusting the parallelism between a conveying roller that conveys recording media and a guiding mechanism that guides reciprocation of a carriage, capable of outputting high-quality images even when a recording head extending in a direction in which recording media are conveyed is used, and capable of high-quality recording at high speed.

According to an aspect of the present invention, a recording apparatus includes a conveying roller configured to convey a sheet, a carriage configured to reciprocate and capable of having a recording head installed therein, a guide shaft configured to guide the carriage, and an adjusting mechanism configured to adjust relative parallelism between the conveying roller and the guide shaft.

Further features of the present invention will become apparent from the following description of exemplary embodiments with reference to the attached drawings.

### BRIEF DESCRIPTION OF THE DRAWINGS

FIG. 1 is a perspective view of a recording apparatus according to a first exemplary embodiment of the present invention viewed from the left front.

FIG. 2 is a longitudinal sectional view of the recording apparatus.

FIG. 3 is a perspective view of a parallelism adjusting mechanism according to the first exemplary embodiment.

FIG. 4 is a perspective view of a parallelism adjusting mechanism according to a second exemplary embodiment.

FIG. 5 is a fragmentary side view illustrating a state where an end portion of a guide shaft is located at the most downstream portion in a sheet conveying direction in a third exemplary embodiment.

FIG. 6 is a fragmentary side view illustrating a state where the end portion of the guide shaft is located at the most upstream portion in the sheet conveying direction.

FIG. 7 is a fragmentary perspective view viewed from inside a chassis when the other end portion of the guide shaft is transferred to the most downstream portion in the conveying direction.

FIG. 8 is a fragmentary perspective view from outside the chassis when the other end portion of the guide shaft is transferred to the most downstream portion in the conveying direction.

FIG. 9 is a fragmentary perspective view illustrating a sensor attached to a carriage in a parallelism adjusting mechanism according to a fourth exemplary embodiment.

FIGS. 10A and 10B illustrate the relationship between the length of a recording head in the conveying direction and displacement on recorded images when the recording head scans a plurality of times. The length of the nozzle lines in the conveying direction is relatively small in FIG. 10A, whereas the length of the nozzle lines in the conveying direction is relatively large in FIG. 10B.

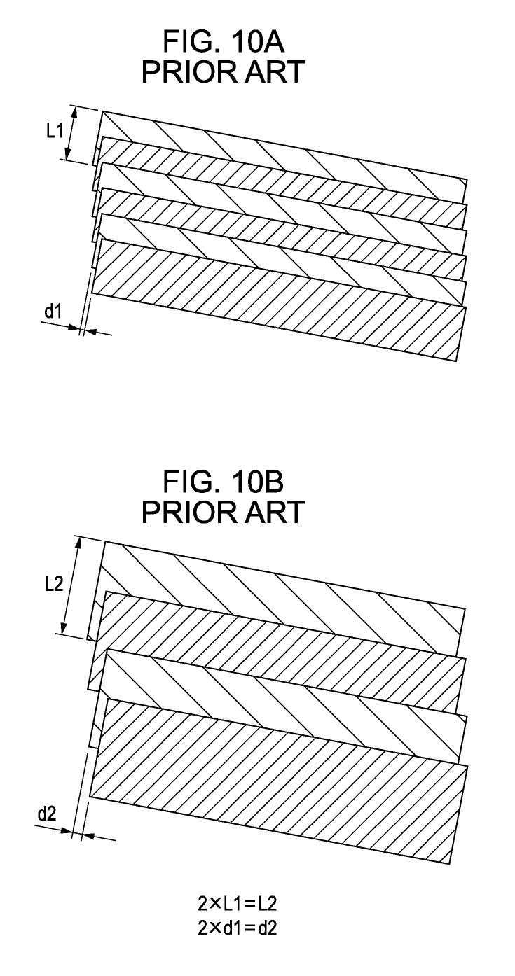

### DESCRIPTION OF THE EMBODIMENTS

### First Exemplary Embodiment

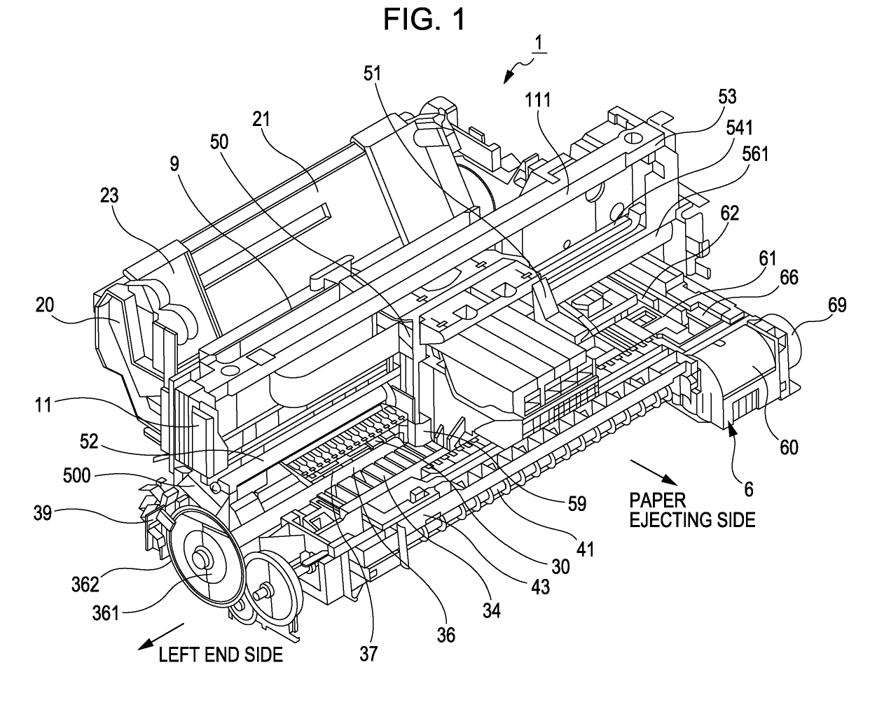

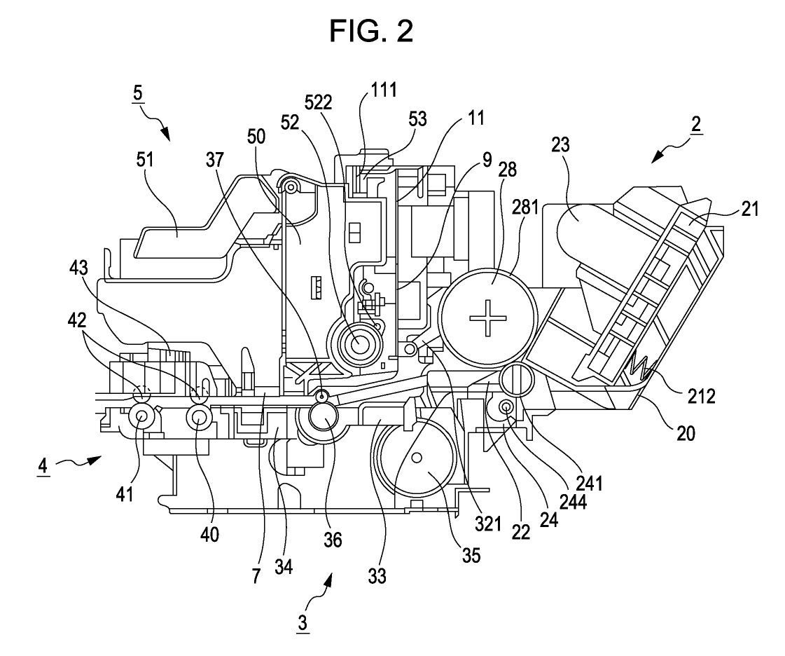

Exemplary embodiments of the present invention will now be described in detail with reference to the drawings. In the drawings, the same reference numbers and symbols are used for the same or corresponding components. FIG. 1 is a perspective view of a recording apparatus 1 according to a first exemplary embodiment of the present invention viewed from the left front. FIG. 2 is a longitudinal sectional view of the recording apparatus 1. The recording apparatus 1 according to this exemplary embodiment includes a paper feeding section 2, a paper conveying section 3, a paper ejecting section 4, a carriage section 5, a recovering section 6, and an electrical section 9. In this exemplary embodiment, an ink-jet recording apparatus that makes a recording by discharging ink from nozzles of a recording head 7 onto recording media on the basis of image information will be described as an example.

The ink-jet recording head 7 serving as a recording unit is installed in a carriage 50 to be reciprocated.

### Paper Feeding Section

The paper feeding section 2 includes a paper feeding base 20 having a pressure plate 21 at which sheets P are stacked, a paper feeding roller 28 that feeds the sheets, a separation roller 241 that separates the sheets into individual sheets, a return lever 22 for returning the sheets to the original stacking position, and the like attached to the paper feeding base 20. A paper feeding tray for retaining the stacked sheets P is attached to the paper feeding base 20 or the exterior of the recording apparatus 1. The paper feeding tray can be of the multistage type, and is in a pulled out position when the tray is in use. The paper feeding roller 28 can be a rod-shaped rotating body having a circular cross section. A roller rubber 281 is disposed on the paper feeding roller 28 at a position adjacent to the reference end of the sheets. The paper feeding roller 28 is driven using a driving force transmitted from a paper feeding motor disposed in the paper feeding section 2 via power transmission gears (not shown), planetary gears (not shown), and the like.

A movable side guide 23 is disposed on the pressure plate 21 so as to regulate the stacking position of the sheets P. The pressure plate 21 is pivotable on a supporting shaft attached to the paper feeding base 20, and is biased to the paper feeding roller 28 by a pressure plate spring 212. A separation sheet is disposed at a position on the pressure plate 21 facing the paper feeding roller 28. The separation sheet is composed of a material having a high frictional coefficient so as to prevent double feeding of a few sheets P that are on the top of the stacked sheets P. The pressure plate 21 can be brought into contact with or be separated from the paper feeding roller 28 using a pressure plate cam (not shown). Furthermore, a separation roller holder 24 that journals the separation roller 241 for separating the sheets P into individual sheets is attached to the paper feeding base 20. The separation roller holder 24 is rotatable about a rotating shaft provided for the paper feeding base 20, and is biased to the paper feeding roller 28 by a separation roller spring (not shown).

The separation roller 241 has a clutch spring attached thereto. With this, a portion to which the separation roller 241 is attached can be rotated when a load larger than or equal to a predetermined value is applied to the separation roller 241. The separation roller 241 can be brought into contact with or be separated from the paper feeding roller 28 using a release shaft 244 and a control cam (not shown). The positions of the pressure plate 21, the return lever 22, and the separation roller 241 can be detected by an auto sheet feeder (ASF) sensor. The return lever 22 for returning the sheets to the original stacking position is attached to the paper feeding base 20 so as to be rotatable, and is biased in a releasing direction by a return lever spring (not shown). The sheets are returned to the original stacking position by rotating the return lever 22 using a control cam (not shown).

Operations of the paper feeding section 2 will now be described. During normal standby, the pressure plate 21 is released using the pressure plate cam (not shown), and the separation roller 241 is released using the control cam (not shown). Furthermore, the return lever 22 is retained at a position so as to return the sheets P to the original stacking position and so as to close a feeding port of the sheets such that the stacked sheets P do not enter the feeding port during stacking. When a sheet feeding process is started, the separation roller 241 is brought into contact with the paper feeding roller 28 by the driving of the motor. Subsequently, the return lever 22 is released, and the pressure plate 21 is brought into contact with the paper feeding roller 28. In this state, feeding of the sheets P is started. Only a predetermined number of sheets P limited by an upstream separator (not shown) provided for the paper feeding base 20 is sent to a nip formed between the paper feeding roller 28 and the separation roller 241. The sheets P are separated into individual sheets at the nip, and only the top sheet is fed to the paper conveying section 3.

When the sheet P reaches a conveying roller unit formed of a conveying roller 36 and pinch rollers 37 (described below), the pressure plate 21 and the paper feeding roller 28 are released using the pressure plate cam (not shown) and the control cam (not shown), respectively. Moreover, the return lever 22 is returned to the position for returning the sheets to the original stacking position using the control cam. At this time, the sheets that have reached the nip formed between the paper feeding roller 28 and the separation roller 241 are returned to the original stacking position by the return lever 22.

### Paper Conveying Section

The paper conveying section 3 is attached to a chassis 11 formed of a bent metal sheet. The paper conveying section 3 includes the conveying roller 36 that conveys the sheets P and a paper end (PE) sensor. The conveying roller 36 can be formed of a metallic shaft whose surface is coated with ceramic microparticles. Both ends of the metallic shaft are journaled by bearings (not shown), and are attached to the chassis 11. Tension springs (not shown) are disposed between the conveying roller 36 and the bearings so as to bias the conveying roller 36, i.e., so as to apply a predetermined load to the conveying roller 36. The tension springs stabilize the conveyance of the sheets by applying a load to the rotating conveying roller 36.

A plurality of pinch rollers 37 that are driven by the conveying roller 36 are in contact with the conveying roller 36. Each of the pinch rollers 37 is held by a pinch roller holder 30, and is pressed into contact with the conveying roller 36 by a pinch roller spring (not shown) so as to generate a conveying force of the sheets P. The rotating shaft of the pinch roller holders 30 is journaled by bearings attached to the chassis 11, and the pinch roller holders 30 are rotated about this rotating shaft. Furthermore, a paper guiding flapper 33 and a platen 34 that guide the sheets are disposed at the entrance of the paper conveying section 3 toward which the sheets P are conveyed. Moreover, a PE sensor lever 321 that transmits the detection of the leading ends and the trailing ends of the sheets P to the PE sensors is provided for the pinch roller holders 30. The platen 34 is positioned and attached to the chassis 11. The paper guiding flapper 33 is engaged with the conveying roller 36. The paper guiding flapper 33 is rotatable about a slidable bearing (not shown), and is positioned when the paper guiding flapper 33 is brought into contact with the chassis 11.

A sheet retainer for covering end portions of the sheets P is disposed on the platen 34 adjacent to the reference end of the sheets. Even when the end portions of the sheets are deformed or curled, the sheet retainer can prevent the floating end portions of the sheets from coming into contact with the carriage 50 and the recording head 7. Furthermore, the recording head 7, serving as a recording unit that records images on the basis of image information, is disposed downstream of the conveying roller 36 in a direction in which the sheets are conveyed. The sheets P fed to the paper conveying section 3 are guided by the pinch roller holders 30 and the paper guiding flapper 33, and sent to the nip formed between the conveying roller 36 and the pinch rollers 37. At this moment, the leading ends of the conveyed sheets are detected by the PE sensor lever 321 such that recording positions on the sheets are calculated.

The sheets P are conveyed along the upper surface of the platen 34 by the conveying roller 36 rotated by a convey motor 35 and the pinch rollers 37 driven by the conveying roller 36. The platen 34 has ribs formed on the surface thereof (serving as a guide surface). These ribs control the gap (distance) between the sheets P and the recording head 7, and at the same time, regulate undulation of the sheets in cooperation with the paper ejecting section 4 (described below). This prevents degradation of image quality caused by the undulation of the sheets on which images are recorded by the recording head. The conveying roller 36 is driven by transmitting the torque of the convey motor 35 formed of a DC motor to a pulley 361 disposed on the shaft of the conveying roller using a timing belt 541.

A code wheel 362 for detecting the conveying distance by the conveying roller 36 is disposed on the shaft of the conveying roller 36. Marks with a pitch of 150 to 300 dpi are formed on this code wheel 362. An encoder sensor 39 for reading out the marks on the code wheel 362 is disposed on the chassis 11 adjacent to the code wheel 362. Separate color ink tanks are attached to the recording head 7 so as to be exchangeable. Moreover, the recording head 7 has nozzle lines including a plurality of nozzles arranged in lines. Images can be recorded on the sheets P by driving heaters (heating elements) inside the nozzles on the basis of recording data such that ink is selectively discharged from the nozzles. The recording head 7 ejects ink from the nozzles in accordance with pressure changes caused by growth or contraction of bubbles by the action of film boiling occurring in the ink inside the nozzles.

### Carriage Section

The carriage section 5 includes the carriage 50 to be reciprocated, the carriage 50 capable of having the recording head 7 installed therein. The carriage 50 reciprocates (main scanning) along a guide shaft 52 and a guide rail 111 that are arranged in a direction intersecting with (usually orthogonal to) the conveying direction of the sheets P. The guide shaft 52 constitutes a guiding mechanism for guiding the reciprocation of the carriage 50. The guide rail 111 supports the rear end portion of the carriage 50 so as to maintain the distance between the recording head 7 and the sheets P at an appropriate value. The guide shaft 52 is formed of a shaft member attached to the chassis 11. The guide rail 111 is integrated with the chassis 11. A sliding sheet 53 composed of SUS or the like is disposed on the guide rail 111 at a portion on which the carriage 50 slides so as to reduce sliding noise.

The carriage 50 is driven by a carriage motor (not shown) attached to the chassis 11 via the timing belt 541. The timing belt 541 is extended at a predetermined tension using a motor pulley and an idle pulley. The timing belt 541 and the carriage 50 are connected to each other via a damper (not shown) composed of rubber or the like. This damper attenuates the vibration of the carriage motor or the like, and reduces unevenness in images or the like. A code strip 561 used for detecting the position of the carriage 50 is disposed parallel to the timing belt 541. For example, bars with a pitch of 150 to 300 dpi are marked on the code strip 561. An encoder sensor (not shown) formed of a photosensor for optically reading the code strip 561 is disposed on a carriage board (not shown) on the carriage 50.

The carriage board disposed on the carriage 50 also includes a contact (not shown) for electrical connection with the recording head 7. The carriage board and the electrical section 9 on the main body are connected to each other via a flexible substrate for transmitting head signals to the recording head 7. The carriage 50 includes an abutting portion (not shown) and a head pushing unit for positioning and fixing the recording head 7. This head pushing unit includes a head set lever 51. That is, the recording head 7 is positioned and fixed by being pushed to the abutting portion by the head set lever 51 that is journaled on the carriage 50 so as to be rotatable.

When images are recorded in the above-described structure, the conveying roller 36 is driven first so as to convey a sheet P to a line position for recording. The carriage 50 is then transferred by the carriage motor (not shown) in a direction perpendicular to the conveying direction, and the recording head 7 is driven on the basis of image information in synchronization with the transfer of the carriage, i.e., ink is selectively discharged from the nozzles arranged in lines on the recording head 7.

### Paper Ejecting Section

The paper ejecting section 4 includes two eject rollers 40 and 41. Driven rollers 42 are pressed into contact with the eject rollers so as to be rotatable in response to the rotation of the eject rollers. The sheet P on which images are recorded is ejected to outside the main body by the eject rollers 40 and 41 rotated in synchronization with the conveying roller 36. The eject rollers 40 and 41 are attached to the platen 34. The first eject roller 40 disposed upstream in the conveying direction can include a metallic shaft and a plurality of rubber portions attached to the metallic shaft. The first eject roller 40 is driven using a driving force transmitted from the conveying roller 36 via idler gears. The second eject roller 41 can include a resin shaft and a plurality of elastic bodies composed of an elastomer or the like attached to the resin shaft. The second eject roller 41 is driven using a driving force transmitted from the first eject roller 40 via idler gears.

The driven rollers 42 can be formed of, for example, SUS sheets having protruding portions on the peripheries thereof and resin portions integrated with the sheets. The driven rollers 42 are attached to a driven roller base 43 via driven roller springs. Moreover, the driven rollers 42 are pressed into contact with the eject rollers 40 and 41 using the spring force of the driven roller springs. The driven rollers 42 can be classified into those for mainly generating the conveying force of the sheets P and those for mainly preventing the sheets P from floating during recording. The driven rollers for generating the conveying force are disposed at positions corresponding to those of the rubber portions of the eject rollers 40 and 41. On the other hand, the driven rollers for preventing the sheets P from floating are disposed at positions where no rubber portions of the eject rollers 40 and 41 lie.

With the above-described structure, the sheets P on which images are recorded using the recording head 7 in the carriage section 5 are ejected to outside the main body while the sheets are nipped between the eject rollers 40 and 41 and the driven rollers 42, and are stacked on a paper output tray. The paper output tray has a structure including a plurality of separate members, and is in a pulled out position when the tray is in use. Moreover, the height of the leading end of the paper output tray is raised as compared with that of the base end, and the height of the side ends is also increased such that the stackability of the ejected sheets P is improved and rubbing on the recording surfaces of the sheets P is prevented.

### Recovering Section

The recovering section 6 includes a dedicated recovering motor 69. In the recovering section 6, the rotation of the recovering motor 69 in one direction actuates a pump 60. The rotation of the recovering motor 69 in the other direction brings a cap 61 into contact with the recording head 7 or separates the cap 61 from the recording head 7, and wipes a blade 62 clean. These operations are switched using, for example, a one-way clutch (not shown). The pump 60 is a suction pump that generates a negative pressure by, for example, squeezing two tubes (not shown) connected to the cap 61 using pump rollers (not shown). The recording head can be recovered through a suction process in which the pump 60 is actuated while the discharge surface of the recording head 7 is capped with the cap 61. Through this suction process, foreign substances such as relatively thicker ink, bubbles, or dust can be sucked and discharged from the nozzles of the recording head 7 together with ink. Thus, ink inside the nozzles can be refreshed, and ink discharge performance of the recording head can be maintained or recovered.

The cap 61 includes an ink absorber disposed inside the cap 61 so as to reduce the amount of ink remaining on the discharge surface of the recording head 7 after the suction process. In order to prevent detrimental effects such as adhesion of the remaining ink to the ink absorber inside the cap 61, idle suction can be performed such that the remaining ink is sucked by actuating the pump 60 while the cap 61 is opened. The waste ink sucked using the pump 60 is collected in a waste ink absorber (not shown) disposed in the lower portion of the recording apparatus 1.

These recovering operations in the recovering section 6, i.e., capping with the cap 61, wiping using the blade 62, and opening or closing a valve (not shown) disposed between the cap 61 and the pump 60, are controlled by a main cam unit (not shown) including a plurality of cams disposed on a common shaft. Moreover, the rotational position of the main cam unit is detected by a position detecting sensor such as a photointerrupter. Moreover, ink adhering to the blade 62 is also removed during a blade cleaning operation performed when the blade 62 is transferred to the innermost position and is brought into contact with a blade cleaner 66.

The above-described mechanical sections are installed in the chassis 11 of the recording apparatus 1, and an outer covering covers the mechanical sections. The outer covering includes, for example, a lower casing, an upper casing, an access cover, a connector cover, and a front cover. Users can access inside the recording apparatus 1 through a predetermined portion in the outer covering, the predetermined portion capable of being opened or closed.

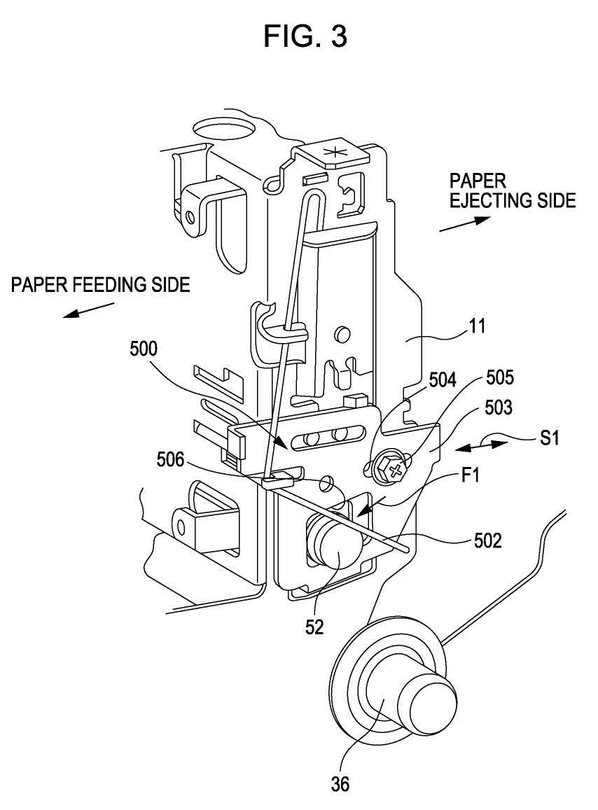

In FIG. 1, the guide shaft 52 constitutes a guiding mechanism for guiding the reciprocation of the carriage 50. A parallelism adjusting mechanism 500 for adjusting the mutual parallelism between the guide shaft 52 and the conveying roller 36 is disposed at an end portion of the guide shaft 52 (left end portion when viewed from the paper ejecting side). FIG. 3 is a perspective view of the parallelism adjusting mechanism 500 according to the first exemplary embodiment. The parallelism adjusting mechanism 500 includes an adjusting member 503 attached to the end portion of the guide shaft 52 (left end portion when viewed from the paper ejecting side in FIG. 1). The adjusting member 503 has a slit 504 extending in the sheet conveying direction. The adjusting member 503 is fixed to the chassis 11 by fastening a screw (or bolt) 505 to a female thread (not shown) formed in the chassis 11 through the slit 504. That is, the adjusting member 503 is fixed to the chassis 11 such that the position of the adjusting member 503 can be adjusted in the sheet conveying direction by the length corresponding to that of the slit 504.

The adjusting member 503 has a shaft engaging slit 506 with which the left end portion of the guide shaft 52 is engaged with a certain clearance in the sheet conveying direction. The left end portion of the guide shaft 52 is urged in the direction of an arrow F1 by a shaft pressing spring 502 attached to the chassis 11. That is, the guide shaft 52 is attached to the adjusting member 503 while being urged to an end surface (adjacent to the paper feeding side, i.e., upstream in the sheet conveying direction, in the drawing) of the shaft engaging slit 506 of the adjusting member 503 using the spring force. When the adjusting member 503 slides in the sheet conveying direction shown by a double-headed arrow S1 in FIG. 3, the guide shaft 52 is also transferred while being in contact with the end surface of the shaft engaging slit 506 of the adjusting member 503.

According to the structure of the parallelism adjusting mechanism 500 shown in FIG. 3, the parallelism between the guide shaft 52 and the conveying roller 36 can be adjusted on a process of assembling the recording apparatus. That is, the left end portion of the guide shaft is transferred in the sheet conveying direction by transferring the adjusting member 503 in the directions of the arrow S1 while the parallelism between the guide shaft 52 and the conveying roller 36 is measured using jigs and tools. The screw 505 is fastened at the most suitable position where the guide shaft 52 becomes parallel to the conveying roller 36, thereby fixing the adjusting member 503 to the chassis 11. With this, the guide shaft 52 and the conveying roller 36 can be accurately assembled with high parallelism. Moreover, in this exemplary embodiment, the adjusting member 503 is attached to an end portion of the guide shaft 52 remote from the recovering section 6. Therefore, changes in the relative positions of the recording head 7 and the recovering section 6 during adjusting of the parallelism of the guide shaft can be minimized. With this, reliability of a process of recovering the recording head 7 in the recovering section 6 can be ensured.

### Second Exemplary Embodiment

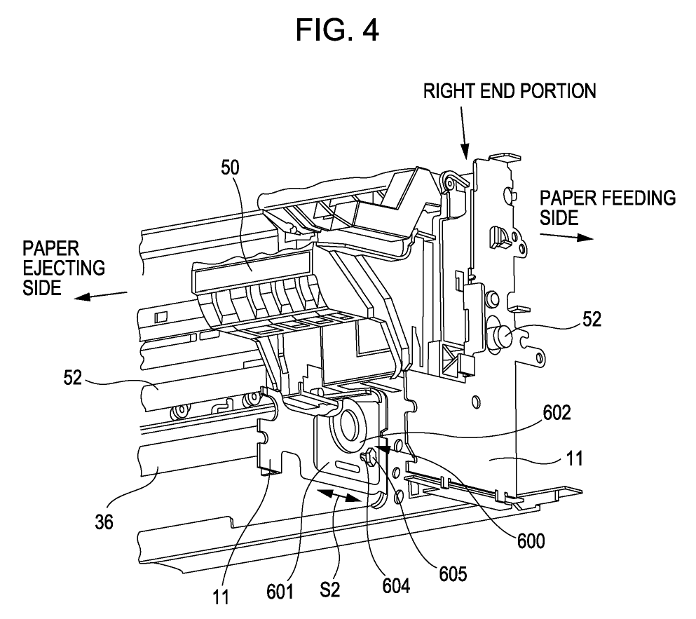

FIG. 4 is a fragmentary perspective view of a parallelism adjusting mechanism 600 according to a second exemplary embodiment. The parallelism adjusting mechanism 600 is disposed at an end portion of the conveying roller 36 adjacent to the recovering section 6, i.e., at the right end portion when viewed from the paper ejecting side. The parallelism adjusting mechanism 600 includes an adjusting member 601 and a conveying roller bearing 602. The adjusting member 601 is attached to the chassis 11 using a screw 605 such that the position of the adjusting member 601 can be adjusted in the sheet conveying direction. The conveying roller bearing 602 journals the right end portion of the conveying roller 36 such that the conveying roller 36 is rotatable, and is attached to the adjusting member 601.

The conveying roller 36 and the conveying roller bearing 602 are urged downward in FIG. 4 by the contact pressure generated by the pinch rollers 37, and are attached to a supporting portion of the adjusting member 601 while being urged downward. The adjusting member 601 is fixed to the chassis 11 using the screw 605 fastened via a slit 604 extending in the sheet conveying direction formed in the adjusting member 601. In this manner, the adjusting member 601 is fixed to the chassis 11 such that the position thereof can be adjusted in the sheet conveying direction shown by a double-headed arrow S2. The position of the right end portion (when viewed from the paper ejecting side) of the conveying roller 36 can be adjusted in the sheet conveying direction by adjusting the position of the adjusting member 601 in the directions of the arrow S2 via the conveying roller bearing 602. In this case, the other end portion of the conveying roller 36 is not substantially transferred in the sheet conveying direction. Thus, the parallelism of the conveying roller 36 with respect to the guide shaft 52 can be adjusted by adjusting the direction of the center of axis of the conveying roller 36, i.e., a direction intersecting with the sheet conveying direction.

According to the second exemplary embodiment, the parallelism between the guide shaft 52 and the conveying roller 36 can be adjusted on the process of assembling the recording apparatus. That is, the adjusting member 601 disposed at an end portion is transferred in the sheet conveying direction while the parallelism between the guide shaft 52 and the conveying roller 36 is measured using jigs and tools. Subsequently, the screw 605 is fastened so as to fix the adjusting member 601 at the most suitable position where the guide shaft 52 and the conveying roller 36 become parallel. With this, the guide shaft 52 and the conveying roller 36 can be accurately assembled with high parallelism. Moreover, a power transmission unit (power transmission mechanisms such as a conveying motor, a gear line, and a pulley) of the conveying roller 36 is disposed at the left end portion when viewed from the paper ejecting side. Therefore, when the parallelism adjusting mechanism 600 is disposed at the other end portion of the conveying roller remote from the power transmission unit, changes in the relative position of the power transmission unit can be minimized. With this, reduction in accuracy in power transmission of the power transmission unit to the conveying roller 36 and unstable operations of the power transmission unit can be prevented.

### Third Exemplary Embodiment

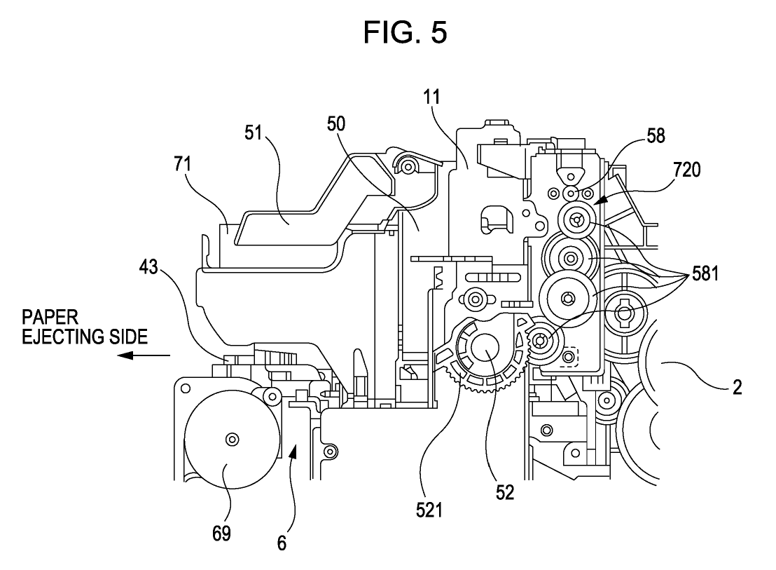

A third exemplary embodiment, in which users can adjust parallelism by themselves, will now be described with reference to FIGS. 5 to 8. A parallelism adjusting mechanism 700 according to the third exemplary embodiment includes a driving unit 720 and a transferring unit 740 disposed at end portions of the guide shaft 52. That is, the driving unit 720 for rotating the guide shaft 52 is disposed at an end portion (right end portion when viewed from the paper ejecting side) of the guide shaft 52, and the transferring unit 740 for transferring the other end portion of the guide shaft 52 in the sheet conveying direction is disposed at the other end portion (left end portion when viewed from the paper ejecting side) of the guide shaft 52.

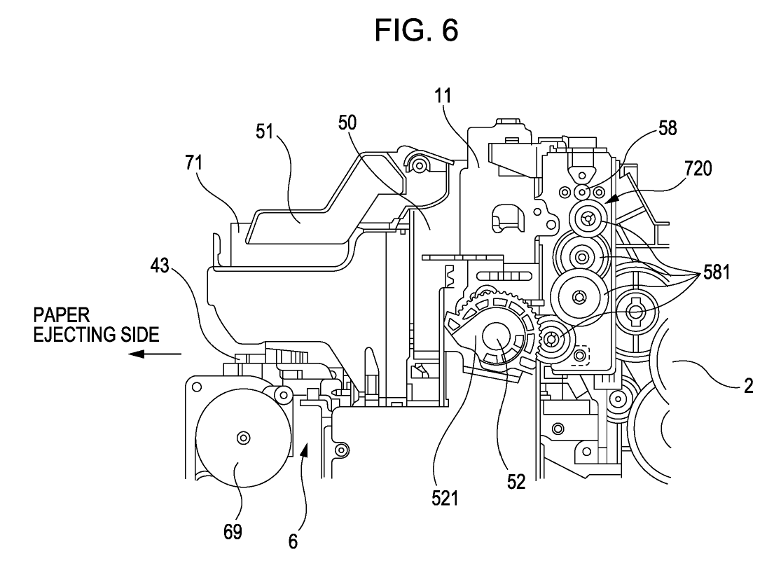

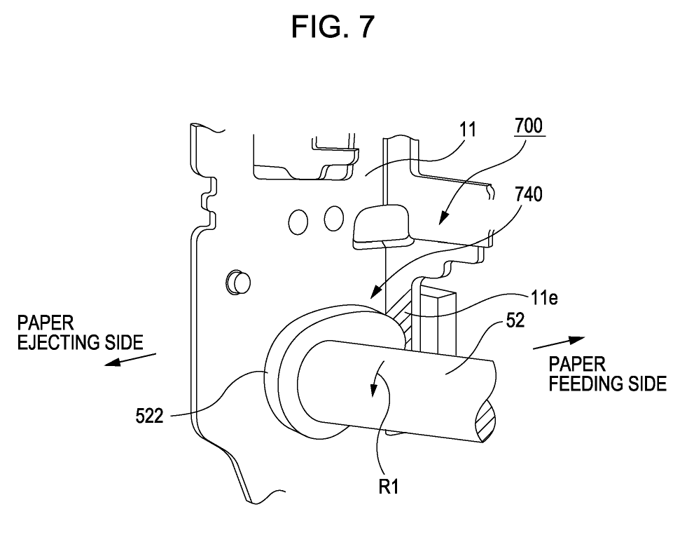

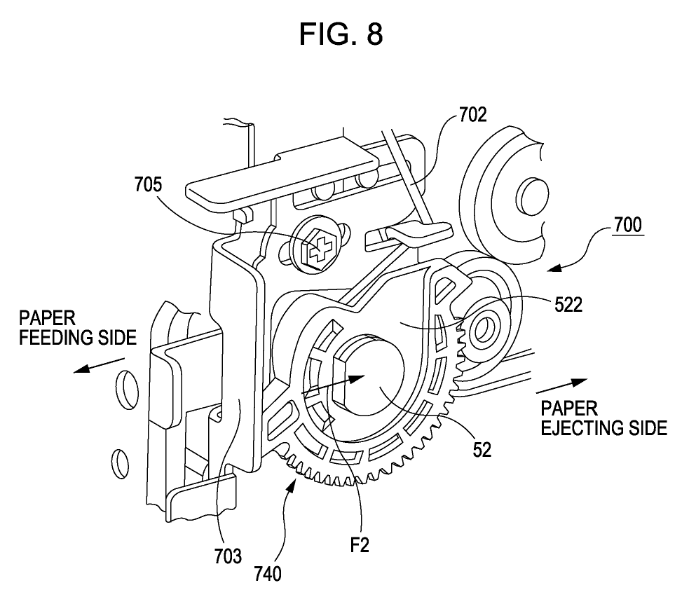

FIG. 5 is a fragmentary side view illustrating a state where the other end portion of the guide shaft is located at the most downstream portion in the sheet conveying direction in the third exemplary embodiment. FIG. 6 is a fragmentary side view illustrating a state where the other end portion of the guide shaft is located at the most upstream portion in the sheet conveying direction. FIG. 7 is a fragmentary perspective view viewed from inside the chassis when the end portion of the guide shaft is transferred to the most downstream portion in the conveying direction. FIG. 8 is a fragmentary perspective view viewed from outside the chassis when the end portion of the guide shaft is transferred to the most downstream portion in the conveying direction.

In FIGS. 5 and 6, an adjusting motor 58 for rotating the guide shaft is attached to the right end portion of the main body. A gear line 581 transmits the driving force of the adjusting motor 58 to a shaft gear 521 disposed at the right end portion of the guide shaft 52. In FIGS. 7 and 8, an eccentric cam 522 is integrated with the left end portion of the guide shaft 52. When the adjusting motor 58 is operated, the guide shaft 52 is driven via the gear line 581 and the shaft gear 521. When the guide shaft 52 is rotated, the eccentric cam 522 is rotated in an integrated manner.

In FIG. 8, the left end portion of the guide shaft 52 is engaged with and supported by a slit, formed in a supporting member 703 and extending in the sheet conveying direction, so as to be movable in the sheet conveying direction. The supporting member 703 is fixed to the chassis 11 using a screw 705. Moreover, the left end portion of the guide shaft 52 is urged in the direction of an arrow F2, i.e., toward the paper ejecting side, inside the slit of the supporting member 703 using a shaft pressing spring 702 attached to the chassis 11. On the other hand, in the state shown in FIG. 7, the eccentric cam 522 disposed at the left end portion of the guide shaft 52 is in contact with an abutting surface (hatched area) 11e of the chassis 11 at a cam surface of the larger radius. Therefore, the position of the left end portion of the guide shaft 52 in the sheet conveying direction is regulated by the shaft pressing spring 702 and the eccentric cam 522. In the state shown in FIG. 7, the left end portion of the guide shaft 52 is located at the most downstream portion (paper ejecting side) in the sheet conveying direction.

When the adjusting motor 58 is operated so as to rotate the guide shaft 52 in the direction of an arrow R1 shown in FIG. 7 from the state shown in FIGS. 7 and 8, the eccentric cam 522 comes into contact with the abutting surface 11e of the chassis at a portion of the smaller radius. In this state, the left end portion of the guide shaft is transferred from the position shown in FIG. 7 to the upstream portion (paper feeding side) in the sheet conveying direction against the pressing force of the shaft pressing spring 702. In this manner, the other end portion of the guide shaft 52 can be transferred to a predetermined position in the sheet conveying direction by rotating the guide shaft 52 to a predetermined rotational position. With this, the parallelism of the guide shaft 52 with respect to the conveying roller 36 can be adjusted.

When parallelism is adjusted using the parallelism adjusting mechanism 700 according to the third exemplary embodiment, test patterns are recorded at predetermined rotational positions of the guide shaft 52 using the recording head 7. The states of the parallelism adjusting mechanism 700 while the test patterns are recorded are memorized in the main body of the recording apparatus. On the other hand, users select a pattern having fewest streaks and least unevenness from the recorded test patterns. When images are recorded, the state where the pattern, selected by the users, is recorded is reproduced. That is, when images are recorded, parallelism is adjusted on the basis of output results of the recorded patterns. With this, shifts or streaks on images caused by a combination of the main body of the recording apparatus and the recording head can be prevented by adjusting parallelism. Thus, image quality can be further improved.

Moreover, in the third exemplary embodiment, the transferring unit 740 including the eccentric cam 522 is disposed at the end portion remote from the recovering section 6 of the guide shaft 52. Therefore, the parallelism between the guide shaft 52 and the conveying roller 36 can be appropriately adjusted while variations in the relative positions of the recording head 7 and the recovering section 6 are minimized. With this, changes in the relative position of the recording head 7 with respect to the recovering section 6 when the carriage 50 is transferred to the recovering section 6 can be minimized, and reliability of the process of recovering the recording head 7 can be ensured.

### Fourth Exemplary Embodiment

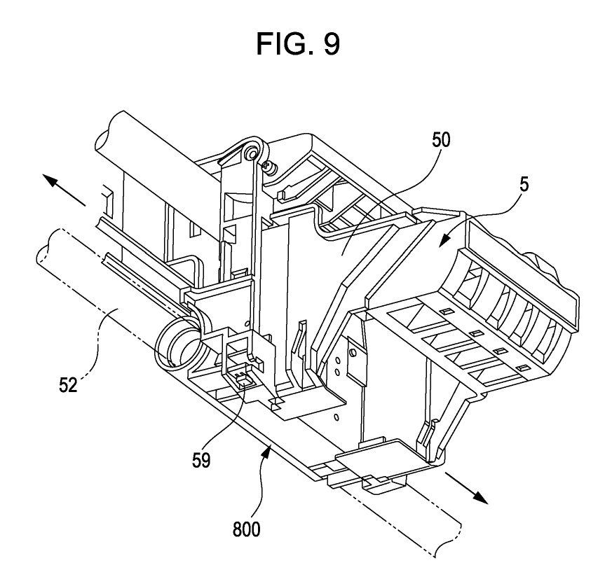

A parallelism adjusting mechanism 800 according to a fourth exemplary embodiment, capable of automatically selecting an optimally recorded pattern using a sensor, will now be described with reference to FIG. 9. In the fourth exemplary embodiment, the parallelism between the conveying roller 36 and the guide shaft 52 is automatically adjusted by operating the driving unit 720 and the transferring unit 740 on the basis of an output result of the recorded test pattern selected using a sensor. FIG. 9 is a fragmentary perspective view illustrating a density sensor 59 attached to the carriage 50 in the parallelism adjusting mechanism 800 according to the fourth exemplary embodiment.

As shown in FIG. 9, the density sensor 59 formed of a reflective photosensor is installed on the carriage 50 that reciprocates along the guide shaft 52 and has the recording head 7 installed in the carriage 50. In this exemplary embodiment, recording of a test pattern at a rotational position of the guide shaft 52 and the density detection (density readout) of the pattern are performed in a series of operations in a collective manner while the rotational position of the guide shaft 52 is changed. After a series of operations is finished at a rotational position of the guide shaft, density determination is conducted at a predetermined rotational position.

When readout of all the patterns at all the rotational positions is finished, a position at which a pattern having a uniform density is recorded is determined as the optimum position, and the optimum position is memorized in the main body of the recording apparatus. According to the fourth exemplary embodiment, onerous operations of selecting a test pattern by users can be omitted.

In the above-described exemplary embodiments, the present invention is applied to an ink-jet recording apparatus. However, the present invention is also applicable to recording apparatuses of other types such as a thermal transfer type, a thermal recording type, a laser beam type, and a wire dot type. Moreover, the present invention is not limited to single recording apparatuses such as printers, copiers, facsimiles, and image forming apparatuses. The present invention is widely applicable to multifunctional systems including combinations of these apparatuses, or applicable to recording apparatuses in multifunctional systems such as computer systems. Moreover, the present invention is similarly applicable to recording apparatuses regardless of the number and the arrangement of recording heads. Moreover, paper, cloth, plastic sheets, overhead transparency films, envelopes, and the like are applicable to sheets serving as recording media regardless of the properties and shapes of the materials as long as images (including letters and symbols) can be recorded on the materials.

According to the exemplary embodiments of the present invention, a recording apparatus capable of relatively adjusting the parallelism between a conveying roller that conveys recording media and a guiding mechanism that guides reciprocation of a carriage, capable of outputting high-quality images even when a recording head extending in a direction in which recording media are conveyed is used, and capable of high-quality recording at high speed can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the priority of Japanese Application No. 2006-210032 filed Aug. 1, 2006, which is hereby incorporated by reference herein in its entirety.

What is claimed is:

1. A recording apparatus comprising:
a conveying roller configured to convey a sheet;
a carriage configured to reciprocate and capable of having a recording head installed therein;
a guide shaft configured to guide the carriage; and
an adjusting mechanism configured to adjust relative parallelism between the conveying roller and the guide shaft in a direction in which the sheet is conveyed.

2. The recording apparatus according to claim 1, wherein the adjusting mechanism adjusts the position of the guide shaft with respect to the conveying roller by adjusting a first end of the guide shaft in the direction in which the sheet is conveyed.

3. The recording apparatus according to claim 2, further comprising:
a recovering section configured to maintain the recording head,
wherein the recovering section is disposed at a second end of the guide shaft, the second end being opposite to the first end.

4. The recording apparatus according to claim 1, wherein the adjusting mechanism adjusts the position of the conveying roller with respect to the guide shaft by adjusting a first end of the conveying roller in the direction in which the sheet is conveyed.

5. The recording apparatus according to claim 4, further comprising:
a power transmission section configured to transmit driving force to the conveying roller,
wherein the power transmission section is disposed at a second end of the conveying roller, the second end being opposite to the first end.

6. The recording apparatus according to claim 1, wherein the adjusting mechanism includes:
a driving section disposed at a first end of the guide shaft and configured to change the rotational position of the guide shaft; and
a transferring section disposed at a second end of the guide shaft and configured to change the position of the guide shaft in the direction in which the sheet is conveyed in accordance with changes in the rotational position of the guide shaft.

7. The recording apparatus according to claim 6, wherein the recording apparatus records test patterns at a plurality of rotational positions of the guide shaft, and adjusts the position of the guide shaft with respect to the conveying roller on the basis of an optimally recorded test pattern.

8. The recording apparatus according to claim 7, wherein a user selects the optimally recorded test pattern.

9. The recording apparatus according to claim 7, wherein the optimally recorded test pattern is selected using a sensor attached to the carriage.

10. The recording apparatus according to claim 1, wherein the recording head is an ink-jet recording head configured to make a recording by discharging ink onto the sheet on the basis of image information.
